(19) United States
(12) Patent Application Publication
(10) Pub. No.: US 2013/0162514 A1
(43) Pub. Date: Jun. 27, 2013

(54) GESTURE MODE SELECTION

(71) Applicants: Jennifer Greenwood Zawacki, Hillsborough, NC (US); Daryl Cromer, Cary, NC (US); Howard Locker, Cary, NC (US); John Weldon Nicholson, Holly Springs, NC (US)

(72) Inventors: Jennifer Greenwood Zawacki, Hillsborough, NC (US); Daryl Cromer, Cary, NC (US); Howard Locker, Cary, NC (US); John Weldon Nicholson, Holly Springs, NC (US)

(73) Assignee: LENOVO (Singapore) PTE, LTD., New Tech Park (SG)

(21) Appl. No.: 13/333,673

(22) Filed: Dec. 21, 2011

(51) Int. Cl. G09G 5/00

(52) U.S. Cl. 345/156

(57) ABSTRACT

An apparatus, system, and method are disclosed for gesture mode selection. An apparatus for gesture mode selection includes a detection module, a gesture mode module, and a gesture recognition module. The detection module detects a triggering event. The gesture mode module sets a gesture mode from an idle mode to an enhanced mode based on the detection of the triggering event. The gesture recognition module processes data from a non-contact input device to detect gestures according to the gesture mode set by the gesture mode module.

### BACKGROUND

1. Field

The subject matter disclosed herein relates to gesture recognition and more particularly relates to gesture mode selection.

2. Description of the Related Art

Gesture recognition involves an input device that is used to recognize movements or gestures performed by a human. Gesture recognition allows for a natural and intuitive interaction with a computing device and can also allow an individual to interact with a computing device from a distance. Exemplary gestures which may be observed by a camera input device may include moving any portion of one's body in a predefined way or assuming a predefined bodily position.

However, gesture recognition can be computation and energy intensive. For example, gesture recognition using a camera may require analysis of numerous pixels of information provided by the camera. In some situations, sensing very small actions or gestures, such as those using fingers or that require only small or precise movement by a user, computational and/or energy requirements can be very high. High computation requirements may lead to high energy costs and may limit a systems battery run time and/or its speed in performing other tasks.

### BRIEF SUMMARY

Based on the foregoing discussion, the inventors have recognized a need for an apparatus, system, and method that selects one of a plurality of gesture recognition modes. Beneficially, such an apparatus, system, and method would reduce computational and energy requirements for a system that performs gesture recognition.

The embodiments of the present invention have been developed in response to the present state of the art, and in particular, in response to the problems and needs in the art that have not yet been fully solved by currently available gesture recognition apparatus, systems, and methods. Accordingly, the embodiments have been developed to provide a method, apparatus, and system for gesture mode selection that overcome many or all of the above-discussed shortcomings in the art.

The apparatus is provided with a plurality of modules configured to functionally execute the necessary steps of gesture mode selection. These modules in the described embodiments include a detection module, a gesture mode module, and a gesture recognition module. The detection module may detect a triggering event. The gesture mode module may set a gesture mode from an idle mode to an enhanced mode based on the detection of the triggering event. The gesture recognition module may process data from a non-contact input device to detect gestures according to the gesture mode set by the gesture mode module.

In one embodiment, the non-contact input device includes a camera. In a further embodiment, the data processed by the gesture recognition module includes a video feed.

In one embodiment, the idle mode includes a coarse gesture mode and the enhanced mode comprises a fine gesture mode. In another embodiment, the idle mode includes an off mode where the gesture recognition module performs no processing to detect gestures and the enhanced mode includes a gesture recognition mode where gestures by a user are detected. In a further embodiment, the gesture recognition module requires less power for processing according to the idle mode than the enhanced mode. The gesture recognition module, in one embodiment, requires less computation resources for processing according to the idle mode than the enhanced mode.

In one embodiment, the triggering event is not initiated based on current user input. In a further embodiment, the detection module detects a triggering event by identifying an event that is listed in a triggering event list. The apparatus, in one embodiment, further includes an update module that updates the triggering event list based on one or more of input from a user and gesture recognition usage data.

In one embodiment, the gesture mode module sets the gesture mode from the enhanced mode to the idle mode at the end of a threshold duration. In another embodiment, the gesture mode module sets the gesture mode from the enhanced mode to the idle mode in response to both the detection module not detecting a triggering event and the gesture recognition module not detecting a gesture during a threshold duration.

A method and computer program product are also presented for gesture mode selection. The method and computer program produce in the disclosed embodiments substantially includes the steps necessary to carry out the functions presented above with respect to the operation of the described apparatus and system. The method and computer program product may include detecting a triggering event. The method and computer program product may include setting a gesture mode from an idle mode to an enhanced mode based on the detection of the triggering event. The method and computer program product may include processing data from a non-contact input device to recognize gestures according to the set gesture mode.

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of the embodiments as set forth hereinafter.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is an external perspective view illustrating one embodiment of a laptop computer in accordance with the present subject matter;

FIG. 2 is a schematic block diagram illustrating one embodiment of a computer system in accordance with the present subject matter;

FIG. 3 is a schematic block diagram illustrating one embodiment of a gesture module in accordance with the present subject matter;

FIG. 4 is a schematic block diagram illustrating another embodiment of a gesture module in accordance with the present subject matter;

FIG. 5 is a table illustrating exemplary gesture modes in accordance with the present subject matter;

FIG. 6A illustrates one embodiment of a coarse gesture in accordance with the present subject matter;

FIG. 6B illustrates one embodiment of a fine gesture in accordance with the present subject matter;

FIG. 7 is a schematic flow chart diagram illustrating one embodiment of a method for gesture mode selection in accordance with the present subject matter; and

FIG. 8 is a schematic flow chart diagram illustrating another embodiment of method for gesture mode selection in accordance with the present subject matter.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more storage devices storing machine readable code. The storage devices may be tangible, non-transitory, and/or non-transmission.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in machine readable code and/or software for execution by various types of processors. An identified module of machine readable code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of machine readable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more storage devices.

Any combination of one or more machine readable medium may be utilized. The machine readable storage medium may be a machine readable signal medium or a storage device. The machine readable medium may be a storage device storing the machine readable code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A machine readable signal medium may include a propagated data signal with machine readable code embodied therein, for example, in baseband or as part of a carrier wave. Such a propagated signal may take any of a variety of forms, including, but not limited to, electro-magnetic, optical, or any suitable combination thereof. A machine readable signal medium may be any storage device that is not a computer readable storage medium and that can communicate, propagate, or transport a program for use by or in connection with an instruction execution system, apparatus, or device. Machine readable code embodied on a storage device may be transmitted using any appropriate medium, including but not limited to wireless, wireline, optical fiber cable, Radio Frequency (RF), etc., or any suitable combination of the foregoing.

Machine readable code for carrying out operations for embodiments may be written in any combination of one or more programming languages, including an object oriented programming language such as Java, Smalltalk, C++ or the like and conventional procedural programming languages, such as the “C” programming language or similar programming languages. The machine readable code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by machine readable code. These machine readable code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The machine readable code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The machine readable code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and machine readable code.

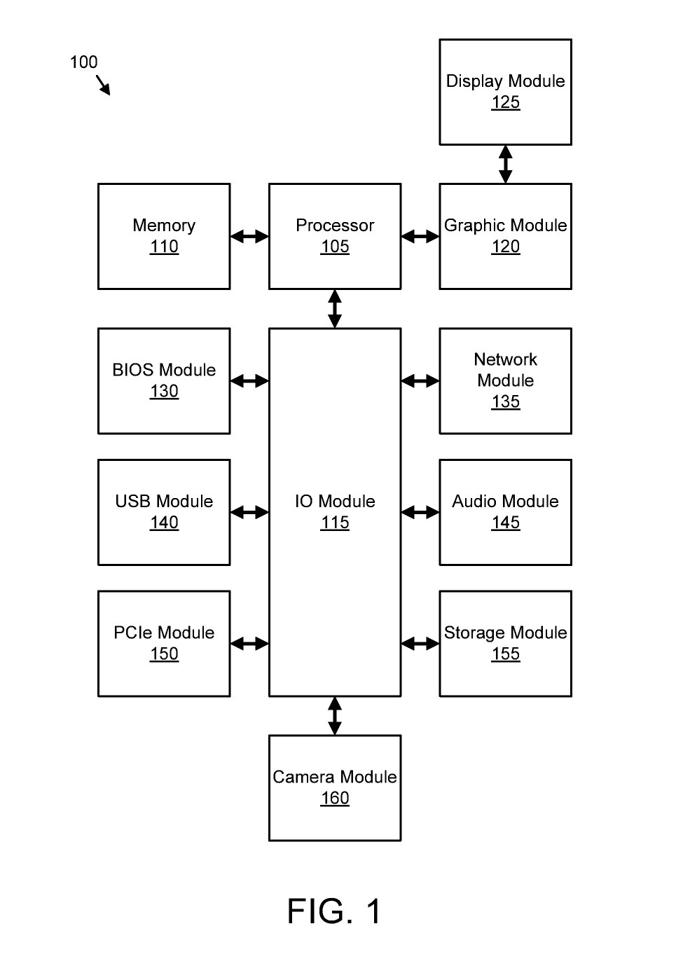

FIG. 1 is a schematic block diagram illustrating one embodiment of an information processing system 100. The information processing system 100 includes a processor 105, a memory 110, an IO module 115, a graphics module 120, a display module 125, a basic input/output system (“BIOS”) module 130, a network module 135, a universal serial bus (“USB”) module 140, an audio module 145, a peripheral component interconnect express (“PCIe”) module 150, a storage module 155, and a camera module 160. One of skill in the art will recognize that other configurations of an information processing system 100 or multiple information processing systems 100 may be employed with the embodiments described herein.

The processor 105, memory 110, IO module 115, graphics module 120, display module 125, BIOS module 130, network module 135, USB module 140, audio module 145, PCIe module 150, storage module 155, and/or camera module 160 referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices. In some embodiments, an information processing system may only include a subset of the components 105-160 shown in FIG. 1.

The memory 110 stores computer readable programs. The processor 105 executes the computer readable programs as is well known to those skilled in the art. The computer readable programs may be tangibly stored in the storage module 155. The storage module 155 may comprise at least one Solid State Device (“SSD”). In addition, the storage module 155 may include a hard disk drive, an optical storage device, a holographic storage device, a micromechanical storage device, or the like.

The processor 105 may include integrated cache to reduce the average time to access memory 115. The integrated cache may store copies of instructions and data from the most frequently used memory 110 locations. The processor 105 may communicate with the memory 110 and the graphic module 120.

In addition, the processor 105 may communicate with the IO module 115. The IO module 125 may support and communicate with the BIOS module 130, the network module 135, the PCIe module 150, the storage module 155, and/or the camera module 106.

The PCIe module 150 may communicate with the IO module 115 for transferring/receiving data or powering peripheral devices. The PCIe module 150 may include a PCIe bus for attaching the peripheral devices. The PCIe bus can logically connect several peripheral devices over the same set of connections. The peripherals may be selected from a printer, a joystick, a scanner, a camera, or the like. The PCI module 150 may also comprise an expansion card as is well known to those skilled in the art.

The BIOS module 130 may communicate instructions through the IO module 115 to boot the information processing system 100, so that computer readable software instructions stored on the storage module 155 can load, execute, and assume control of the information processing system 100. Alternatively, the BIOS module 130 may comprise a coded program embedded on a chipset that recognizes and controls various devices that make up the information processing system 100.

The network module 135 may communicate with the IO module 115 to allow the information processing system 100 to communicate with other devices over a network. The devices may include routers, bridges, computers, information processing systems, printers, and the like. The display module 125 may communicate with the graphic module 120 to display information. The display module 125 may include a cathode ray tube (“CRT”), a liquid crystal display (“LCD”) monitor, or the like. The USB module 140 may communicate with one or more USB compatible devices over a USB bus. The audio module 145 may generate an audio output.

The camera module 160 may communicate with the IO module 115 for transferring and/or receiving data between the information processing system 100 and a camera. In one embodiment, the camera module 160 may include a camera. In one embodiment, The one or more of the other components 105-155 may perform the functions of the camera module 160. For example, a camera device may be USB compatible and/or PCIe compatible and may be connected to the USB module 140 or the PCIe module 150.

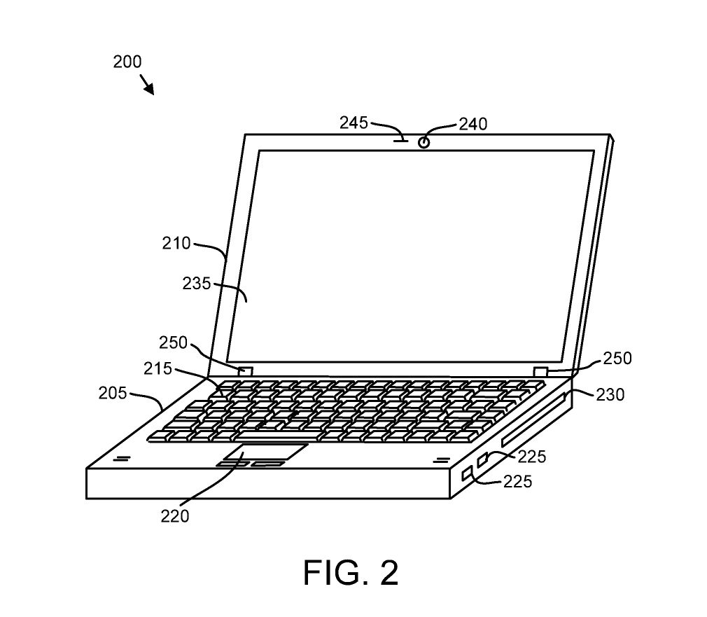

FIG. 2 depicts one embodiment of laptop computer 200 in accordance with the present subject matter. In one embodiment, the laptop computer 202 is one embodiment of an information processing system 100. As shown in the figure, a laptop computer 200 may include a keyboard-side casing 205 and a display-side casing 210. The keyboard-side casing 205 may be provided with exemplary input devices such as the depicted keyboard 215, touchpad 220, and/or any other input devices. The keyboard-side casing 205 may also be provided with one or more I/O ports 225 and/or an optical drive 230. The display-side casing 210 may be provided with a display screen 235, an integrated camera 240, and a microphone 245.

The integrated camera 240 may be arranged such that it is capable of picking up an image of a subject in front of the computing system 200. For example, a person sitting at the keyboard 215 of the computing system 200 may be visible in an image captured by the integrated camera 240. Some embodiments may not include an integrated camera 204. Some embodiments may receive data from a separate camera device such as through one of the I/O ports 225. In the depicted embodiment, the keyboard-side casing 205 and the display-side casing 210 are connected by a pair of left and right connecting members (hinge members) 250, which support the casings in a freely openable and closable manner.

The laptop computer 200 is only one embodiment of an information processing system 100 which may be used in accordance with the present subject matter. Other types of information processing systems may include, but are not limited to, a phone, a tablet computer, a pad computer, a personal digital assistant (PDA), and a desktop computer.

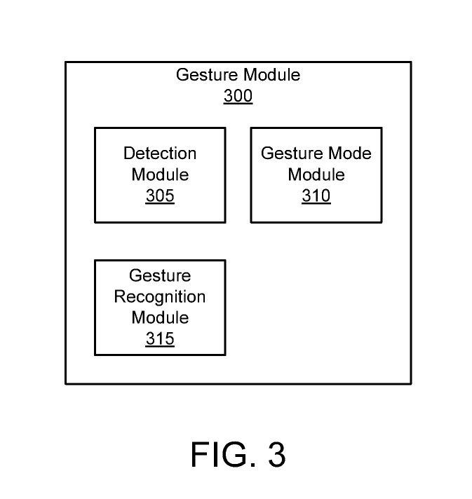

FIG. 3 is a schematic block diagram illustrating one embodiment of a gesture module 300 in accordance with the present subject matter. In one embodiment, the gesture module 300 includes a detection module 305, a gesture mode module 310, and a gesture recognition module 315. In one embodiment, the gesture module 300 and its sub modules 305-315 may be included in the information processing system 100 of FIG. 1. In one embodiment, the gesture module 300 may be included in the camera module 160. In one embodiment, the gesture module 300 may be embodied as code loaded into memory 110 and/or stored by the storage module 155. In one embodiment, the gesture module 300 may be embodied in hardware and/or circuitry.

In one embodiment, the detection module 305 detects a triggering event. In one embodiment, a triggering event may be an event that has been designated as a triggering event. In one embodiment, a triggering event includes one or more of any event that occurs on an information processing system 100. For example, the execution of a portion of code, an error message, or any other event on the information processing system 100 may be a triggering event.

In one embodiment, the triggering event includes an event not initiated by a user. For example, the event may not have been initiated by a user of a device or system which includes the gesture module 300. For example, if the gesture module 300 is included in the laptop computer 200 of FIG. 2 the triggering event may not include events initiated by a user of the laptop computer. In one embodiment, an event not initiated by a user may include system events such as error messages, messages regarding received data, a message of the beginning of a task, or other events. For example, an event not initiated by a user may include the receipt of a message from another device such as an email, text message, or other message.

In one embodiment, the triggering event does not include current user input. For example, the triggering event may not include input currently provided by a user through an input device such as a keyboard, mouse, touch screen, etc.

In one embodiment, the triggering event may be initiated by a user but may not be initiated based on current user input. For example, a user may schedule the performance of some task or event on an information processing system 100 that includes the gesture module 300. In one embodiment, a triggering event that is not initiated based on current user input may include a scheduled event, the receipt of data such as a message, an error message, or numerous other events. In one embodiment, a triggering event that is not initiated based on current user input may be based on non-current user input such as input provided at a previous time to schedule an event or task. In one embodiment, current user input may include input that is meant to cause an immediate or substantially immediate event. For example, the starting of a program based on a user double clicking an icon corresponding to the program may be an event initiated based on current user input. On the other hand however, an error message, scheduled task, appointment reminder, or other similar events may not be based on current user input.

In one embodiment, the triggering event may be that a user appears to be performing a gesture. For example, the gesture recognition module 315 may determine that a user appears to be performing a gesture and may notify the detection module 305 of the event. The detection module 305 may detect this occurrence as a triggering event. The determination that a user appears to be performing a gesture will be discussed further below in relation to the gesture recognition module 315.

In one embodiment, the detection module 305 may detect a triggering event based on an occurring event being on a triggering event list. In one embodiment, for example, the detection module 305 may reference or maintain a triggering event list which includes events that are triggering events. In one embodiment, the events on the triggering event list may be added, removed, or updated by a user and/or gesture module 300. In one embodiment, the events on the triggering event list may include any event that may occur in an information processing system 100. In one embodiment, the events on the triggering event list may include triggering events subject to one or more of the limitations discussed above.

In one embodiment, the detection module 305 may compare an occurring event to the events on a triggering event list to determine if the occurring event is a triggering event. If the occurring event is on the triggering event list, the detection module 305 may detect the occurring event as a triggering event. If the occurring event is not on the vent list, the detection module 305 may not treat the occurring event as a triggering event.

In one embodiment, the gesture mode module 310 sets a gesture mode from an idle mode to an enhanced mode based on detection of a triggering event. For example, the gesture module module 310 may set a gesture mode to an enhanced mode in response to the detection module 305 detecting a triggering event.

In one embodiment, the gesture mode module 310 may set the gesture mode back from the enhanced mode to the idle mode at the end of a threshold duration. For example, the gesture mode module 310 may start a threshold duration timer upon detection of a triggering event by the detection module 305 and reset the gesture mode from the enhanced mode back to the idle mode at the end of the threshold duration. In one embodiment, the gesture mode module 310 may set the gesture mode from the enhanced mode to the idle mode in response to both the detection module not detecting a triggering event and the gesture recognition module not detecting a gesture during a threshold duration. For example, if during a threshold duration neither another triggering event has been detected nor a gesture recognized, the gesture mode module 310 may set the gesture mode to an idle mode.

In one embodiment, the gesture recognition module 315 processes data from a non-contact input device to detect gestures according to the gesture mode set by the gesture mode module 310. For example, if the gesture mode module 310 has set the gesture mode to an idle mode, the gesture recognition module 315 may process data from a non-contact input device according to the idle mode. On the other hand, if the gesture mode is an enhanced mode, the gesture recognition module 315 may process data from a non-contact input device according to the enhanced mode.

In one embodiment, the non-contact input device may be any type of input device that does not require contact between the input device and a user. For example, a camera may be used as a non-contact input device in that data may be input into an information processing system 100 or other device without the user contacting the camera. Exemplary non-contact input devices include cameras, proximity sensors, dimension sensors such as the Microsoft Kinect®, infrared sensors, or the like.

In one embodiment, data from a non-contact input device may be provided to the gesture module 300. In one embodiment, the gesture recognition module 315 processes the data from the non-contact input device. In one embodiment, the non-contact input device includes a camera and the data processed by the gesture recognition module comprises a video feed. In one embodiment, the gesture recognition module 315 may include code that controls the processing of a data feed from a non-contact input device by a processor 105. In one embodiment, a gesture mode may control the processing of the data from the non-contact input device.

In one embodiment, the gesture recognition module 315 may process data provided by a camera. For example, the camera may provide a series of images capture by the camera. In one embodiment, a user may position himself or herself within a range where the use is observable by the camera. The data provided by the camera may then include images that of the user.

In one embodiment, the gesture recognition module 315 may process data from a camera by identifying shapes within images and/or detecting changes between images. For example, the gesture recognition module 315 may use detection and/or recognition algorithms that can determine the location and positions of certain portions of a user's body within an image. For example, the gesture recognition module 315 may detect a user's head, arms, legs, fingers, or any other portion/feature of user's body by analyzing pixels within an image. In one embodiment, by detecting positions and/or detecting change positions of the user the gesture recognition module 315 may detect movements or gestures performed by the user.

In one embodiment, a gesture mode may include one or more settings that control how gestures are detected or recognized. For example, a gesture mode may control how the gesture recognition module 315 processes and/or detects gestures. The settings may include settings that affect the amount of electrical power and/or computation resources are required to perform the processing of the data from the non-contact input device. For example, the gesture recognition module 315 may require less power for processing according to the idle mode than the enhanced mode. As another example, the gesture recognition module 315 may require less computation resources for processing according to the idle mode than the enhanced mode.

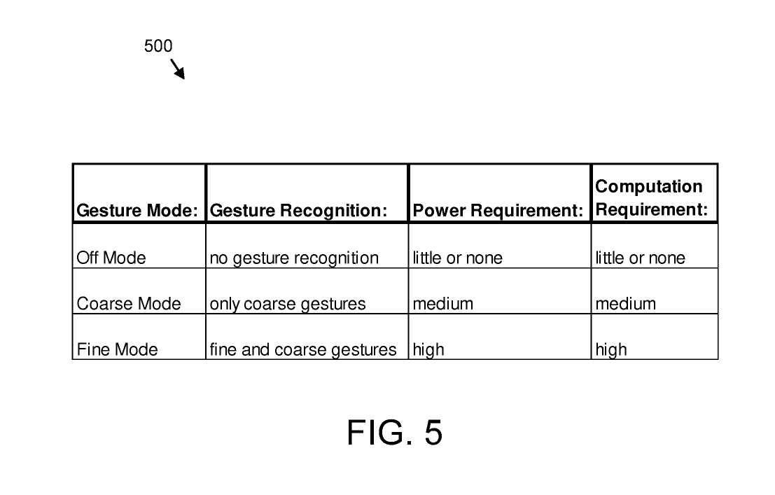

FIG. 5 illustrates a table 500 of exemplary gesture modes in accordance with the present subject matter. In the depicted table 500, the gesture modes include an off mode, a coarse mode, and an enhanced mode.

In one embodiment, an off mode includes a mode where no gesture recognition is performed. For example, the off mode may include settings such that no processing of data from a non-contact input device is performed. For example, the data may simply be ignored or discarded or a non-contact input device may be powered off. In one embodiment, the off mode will not recognize any gestures because no processing of data from the non-contact input device is performed. The off mode may require little or no power by the gesture recognition module 315 because no processing for gesture recognition is performed. The off mode may also require little or no computation resources.

In one embodiment, a coarse mode includes a mode where only some, but not all gestures, are recognized. In one embodiment, the coarse mode includes settings such that some gesture recognition is performed but not all gestures will be recognized. For example, the coarse mode may utilize lower power and/or lower computation intense settings such that gestures which require higher power and/or computation will not be recognized. In one embodiment, the coarse mode may have medium power requirements in that it requires more power than an off mode but less power than a fine mode. Similarly, the coarse mode may have medium computation requirements in that it requires more computation than an off mode but less computation than a fine mode. In one embodiment, only coarse gestures will be recognized in the coarse gesture mode while fine gestures will not be recognized.

According to one embodiment, coarse gestures that are recognizable by the gesture recognition module 315 in the coarse mode may include gestures that require relatively large amounts of body movement. For example, wide movements using appendages such as arms or legs, or movements of the whole body, may create considerably changes between images captured by a camera. For example, a large amount of pixels may change between a series of images. In one embodiment, large amount of changing pixels are easier to detect by the gesture recognition module 315. Thus, coarse gestures may be easier to detect and/or recognize.

In one embodiment, although a fine gesture may not be recognizable it may be possible to determine that a fine gesture is being performed. For example, the gesture recognition module 315 may be able to detect movement that does not amount to a coarse gesture. In one embodiment, the gesture recognition module 315 may be able to determine that the movement is not sufficient for a coarse gesture and thus may determine that a user is attempting to perform a fine gesture. In one embodiment, the gesture recognition module 315 may be able to detect movement but it may not be able to detect with enough accuracy the gesture that is being performed. In such cases, the gesture recognition module 315 may determine that a fine gesture is being performed.

Thus, even though a specific fine gesture may not be recognizable or detectible in the coarse mode, it may be possible to determine in general that a fine gesture is being performed. In one embodiment, upon a determination that the user appears to be performing a fine gesture, the gesture recognition module 315 may notify the detection module 305 and/or the gesture mode module 310 and the gesture mode may be switched to an enhanced or fine gesture mode.

In one embodiment, a fine mode includes a mode where all gestures are recognized. For example, the fine mode may perform a maximum level of power and/or computation such that all gestures may be recognized when in the fine mode. In one embodiment, the fine mode will enable the gesture recognition module 315 to recognize both fine and coarse gestures. In one embodiment, the fine mode may result in higher power and computation requirements than a coarse mode or off mode.

According to one embodiment, fine gesture may include relatively small amounts of body movement. For example, fine gestures may include subtle movements of the arm or body and/or the movements of small portions of the body such as fingers, eyes, etc. In one embodiment, only a few pixels may change between images in a data feed from a camera. In one embodiment, detecting small changes between images may require more computation and/or larger amounts of power.

Although FIG. 5 depicts only an off mode and two gesture recognition modes, the coarse mode and the fine mode, one of skill in the art that three or more gesture recognition modes may be used in some embodiments. For example, the gesture modes may include a medium mode in some embodiments that has power and/or computation requirements between the coarse mode and the fine mode.

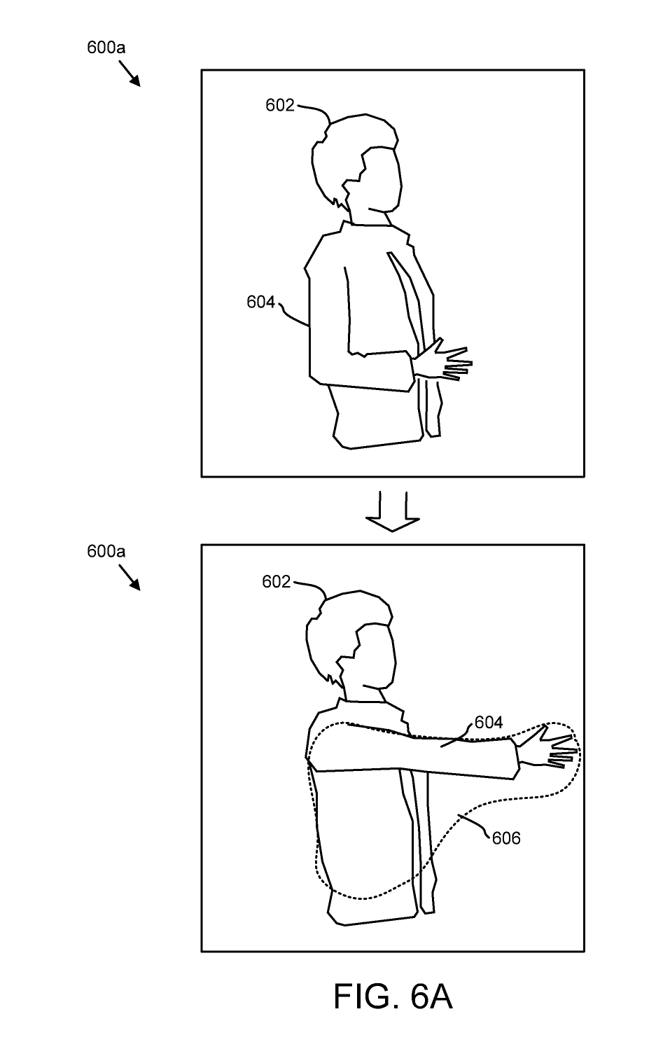

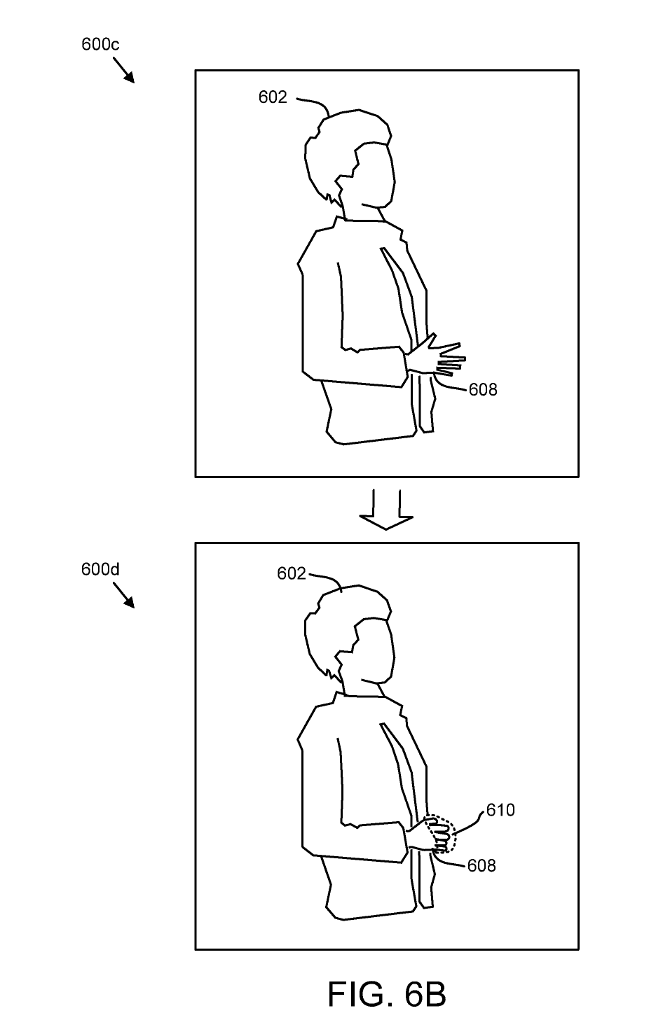

FIGS. 6A and 6B illustrate exemplary gestures which may be detected by the gesture recognition module 315. FIG. 6A illustrates an exemplary first image 600a and second image 600b for one embodiment of a coarse gesture. According to one embodiment, the first image 600a precedes the second image 600b by one or more images in a video stream provided by a camera. For example, one or more images may be in between the first image 600a and second image 600b in a data stream provided by a camera.

The first image 600 shows a user 602 in a beginning position for the coarse gesture and second image 600b shows user 602 in an ending position for the coarse gesture. In the beginning position the user 602 is shown with the user's arm 604 bent and at the user's 602 side. In the ending position the user 602 is shown with the user's arm 604 straight and extended forward in front of the user. In one embodiment, the user 602 moves from approximately the beginning position of image 600a to the ending position of FIG. 600b perform the exemplary coarse gesture.

In one embodiment, the coarse gesture of FIG. 6A may result in a large amount of pixels changing between a series of images provided by a camera. For example, each of the pixels within region 606 may have changed during the gesture. According to one embodiment, due to the large amount of changing pixels, the gestures may be easier to detect and recognize. For example, even in a low power mode where computation resources and power are conserved the coarse gesture may be recognized.

FIG. 6B illustrates an exemplary third image 600c and fourth image 600d for one embodiment of a fine gesture. The third image 600c shows a user 602 in a beginning position for the fine gesture and the fourth image 600d shows user 602 in an ending position for the fine gesture. In the beginning position the user 602 is shown with the user's hand 608 in an open position with fingers extended. In the ending position the user 602 is shown with the user's hand 608 in a closed position to form a fist. In one embodiment, the user 602 moves from approximately the beginning position of image 600a to the ending position of FIG. 600b perform the exemplary fine gesture.

In one embodiment, the fine gesture of FIG. 6B may result in a relatively small amount of pixels changing between a series of images provided by a camera. For example, only the pixels within region 610 may have changed during the gesture. According to one embodiment, due to the small amounts of changing pixels, the fine gesture may be more difficult to detect and recognize. For example, in a low power mode where computation resources and power are conserved the fine gesture may not be recognized. In one embodiment, a high amount of computation resources and/or power may be required to detect the fine gesture of FIG. 6B. As discussed above, even if the fine gesture of FIG. 6B is not detectable in a coarse mode it may still be possible to detect some movement in the coarse mode and determine that a fine gesture is being performed.

Returning to FIG. 3, and as discussed previously, the gesture mode module 310 may set a gesture mode from an idle mode to an enhanced mode in response to the detection of a triggering event. In one embodiment, the idle mode is a coarse gesture mode and the enhanced mode is a fine gesture mode. In another embodiment, the idle mode is an off mode where the gesture recognition module performs no processing to detect gestures and the enhanced mode is a gesture recognition mode where gestures by a user are detected. For example, the enhanced mode is a gesture recognition mode such as a coarse mode or a fine mode. In one embodiment, the gesture recognition module 315 requires less power for processing according to the idle mode than the enhanced mode and/or requires less computation resources for processing according to the idle mode than the enhanced mode.

In one embodiment, the idle mode and/or the enhanced mode may designated as any of the off mode, coarse mode, and the fine mode. In one embodiment, a user may be able to customize settings where the idle mode points to a desired mode and/or the enhanced mode points to a desired mode.

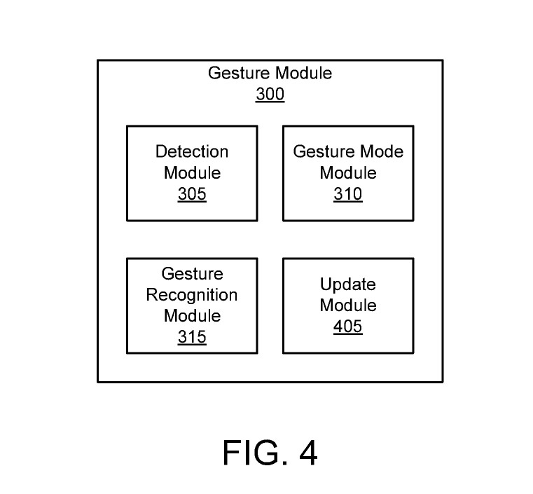

FIG. 4 is a schematic block diagram illustrating another embodiment of a gesture module 300 in accordance with the present subject matter. The gesture module 300 includes a detection module 305, gesture mode module 310, and a gesture recognition module 315 which may include any of the variations discussed above. The gesture module 300 of FIG. 4 also includes an update module 405.

In one embodiment, the update module 405 updates a triggering event list. For example, the triggering event list may be a list of events that should be treated as triggering events. In one embodiment, the update module 405 may add, remove, or modify one or more of the events on the vent list. For example, the update module 405 may add an event to the triggering event list which the detection module 305 should treat as a triggering event in the future.

In one embodiment, the update module 405 may update the triggering event list based on input from a user. For example, a user may be able to add or remove events from the triggering event list so that an enhanced mode is triggered upon the occurrence of desired events. In one embodiment, the update module 405 may update the triggering event list based on gesture recognition usage data. For example, the update module 405 may log how frequently a gesture is detected following the setting of a gesture mode from an idle mode to an enhanced mode. For example, if gestures are never detected after an enhanced mode has been set following the occurrence of a specific event, the specific event may be removed from the triggering event list.

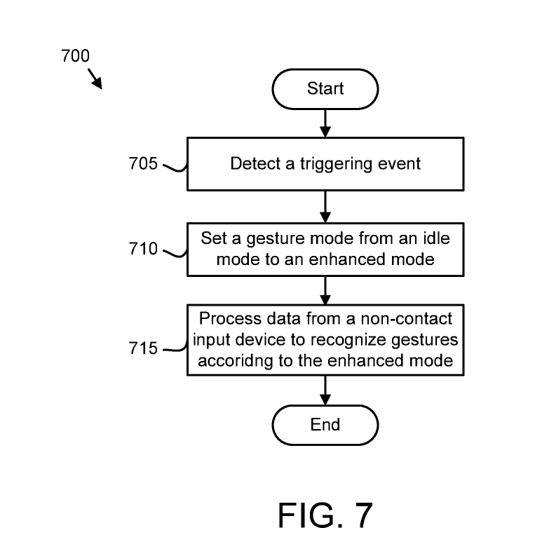

FIG. 7 is a schematic flow chart diagram illustrating one embodiment of a method 700 for gesture mode selection in accordance with the present subject matter. In one embodiment, the method 700 may be implemented by an information processing system 100 and/or a gesture module 300.

In one embodiment, the method 700 includes detecting 705 a triggering event. For example, the detection module 305 may detect 705 a triggering event. In one embodiment, the detection module 305 detects 705 the triggering event by comparing an occurring event with events on a triggering event list. If the event is on the triggering event list the detection module 305 may determine that the event is a triggering event.

In one embodiment, a triggering event is an event that is not initiated based on current user input. In another embodiment, the triggering event is an event that is not based on user input. In one embodiment, the triggering event includes the gesture recognition module 315 determining that a user appears to be performing a gesture. For example, the gesture recognition module 315 may be processing camera data according to a coarse mode but may determine that the user is performing a fine gesture. In one embodiment, this may be a triggering event which the detection module 305 can then detect 305.

In one embodiment, the method 700 includes setting 710 a gesture mode from an idle mode to an enhanced mode. In one embodiment, the idle mode is a coarse gesture mode and the enhanced mode is a fine gesture mode. In another embodiment, the idle mode is an off mode where the gesture recognition module performs no processing to detect gestures and the enhanced mode is a gesture recognition mode where gestures by a user are detected. For example, the enhanced mode is a gesture recognition mode such as a coarse mode or a fine mode.

In one embodiment, the method 700 includes processing 710 data from a non-contact input device to recognize gestures according to the enhanced mode. In one embodiment, the gesture recognition module 315 may process the data from the non-contact input device based on the gesture mode set by a gesture mode module 310. In one embodiment, the power and computation requirements for the processing 715 may depend on the gesture mode set by the gesture mode module 310. In one embodiment, the gesture recognition module 315 requires less power for processing according to the idle mode than the enhanced mode and/or requires less computation resources for processing according to the idle mode than the enhanced mode.

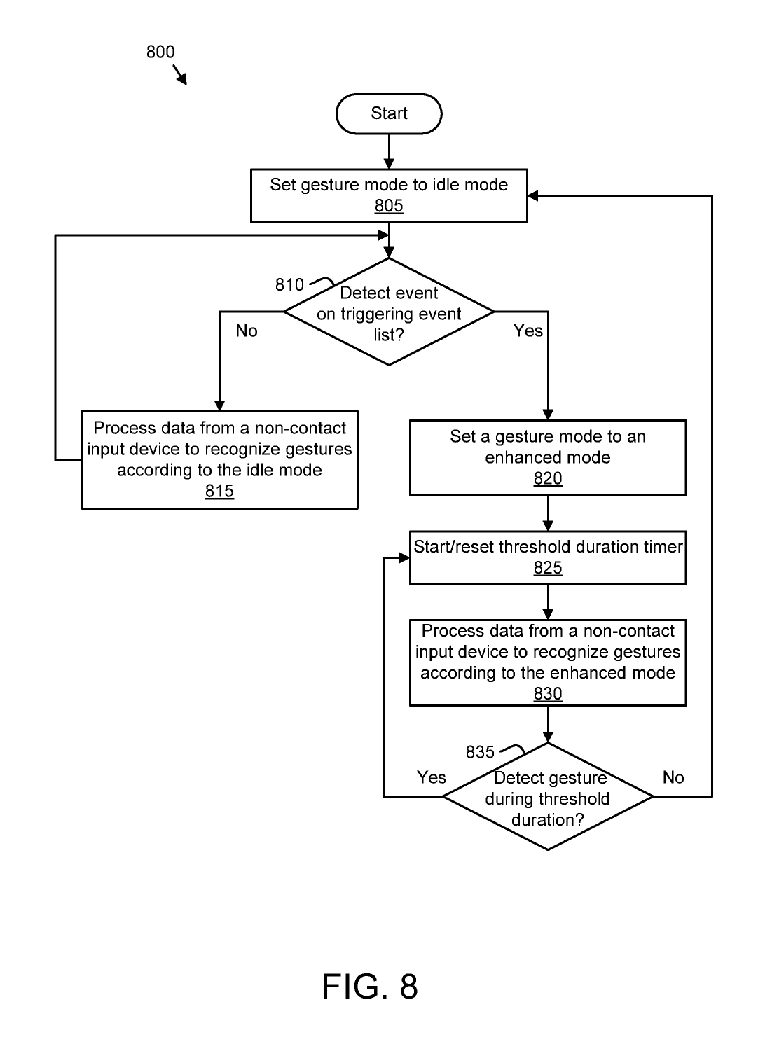

FIG. 8 is a schematic flow chart diagram illustrating another embodiment of a method 800 for gesture mode selection in accordance with the present subject matter. The method 800 will be described below in relation to the method 800 being implemented by a gesture module 300. However, it will be clear to one skilled in the art that the method 800 may be implemented by devices, systems, or apparatuses other than the gesture module 300.

The method 800 begins and the gesture mode module 310 sets 805 the gesture mode to an idle mode. The idle mode may be any mode that is designated as the idle mode. For example, the idle mode may be an off mode or a coarse gesture mode.

The detection module 305 determines 810 whether an event on a triggering event list has been detected. If the detection module 305 does not detect an event on the triggering event list (No at 810) then the gesture recognition module 315 processes 815 data from a non-contact input device to recognize gestures according to the idle mode. The detection module 305 may continue to determine 810 whether a triggering event has been detected 810.

If the detection module 305 does detect an event on the triggering event list (Yes at 810) then the gesture mode module 310 sets 820 sets a gesture mode to an enhanced mode. In one embodiment, the enhanced mode may be a gesture mode that requires more power or more computation than the idle mode. In one embodiment, the enhanced mode is a coarse mode or a fine mode.

The gesture mode module 310 starts/rests 825 a threshold duration timer. In one embodiment, the threshold duration timer times a duration during which the gesture mode will be in the enhanced mode. In one embodiment, the threshold duration timer acts as a timer which determines when the gesture mode module 310 will set the enhanced mode back to the idle mode.

The gesture recognition module 315 processes 830 data from the non-contact input device to recognize gestures according to the enhanced mode. In one embodiment, the enhanced mode allows the gesture recognition module 315 to detect gestures. In one embodiment, the enhanced mode allows the gesture recognition module 315 to detect more gestures than could be detected under the idle mode. For example, the enhanced mode may be a fine mode where fine and coarse gestures are detectable and the idle mode may be a coarse mode where coarse gestures are detectable but fine gestures are not detectable.

The gesture mode module 310 may determine 835 whether a gesture has been detected during the threshold timer. If the gesture mode module 310 determines 835 that a gestures has been detected (Yes at 835) then the gesture mode module 810 may start/reset 825 the threshold duration timer. In one embodiment, the gesture mode may remain in the enhanced mode. If the gesture mode module 310 determines 835 that a gestures has not been detected (No at 835) then the gesture mode module may set 805 the gesture mode to an idle mode.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
one or more storage devices storing machine readable code;
one or more processors executing the machine readable code, the machine readable code comprising:
a detection module detecting a triggering event;
a gesture mode module setting a gesture mode from an idle mode to an enhanced mode based on the detection of the triggering event; and
a gesture recognition module processing data from a non-contact input device to detect gestures according to the gesture mode set by the gesture mode module.

2. The apparatus of claim 1, wherein the non-contact input device comprises a camera and wherein the data processed by the gesture recognition module comprises a video feed.

3. The apparatus of claim 1, wherein the idle mode comprises a coarse gesture mode and the enhanced mode comprises a fine gesture mode.

4. The apparatus of claim 1, wherein the idle mode comprises an off mode where the gesture recognition module performs no processing to detect gestures and the enhanced mode comprises a gesture recognition mode where gestures by a user are detected.

5. The apparatus of claim 1, wherein the gesture recognition module requires less power for processing according to the idle mode than the enhanced mode.

6. The apparatus of claim 1, wherein the gesture recognition module requires less computation resources for processing according to the idle mode than the enhanced mode.

7. The apparatus of claim 1, wherein the triggering event is not initiated based on current user input.

8. The apparatus of claim 1, wherein the idle mode comprises a coarse mode and wherein the triggering event comprises the gesture recognition module determining that a user appears to be performing a fine gesture.

9. The apparatus of claim 1, wherein the detection module detects a triggering event by identifying an event that is listed in a triggering event list.

10. The apparatus of claim 8, further comprising an update module, the update module updating the triggering event list based on one or more of:
input from a user; and
gesture recognition usage data.

11. The apparatus of claim 1, wherein the gesture module further sets the gesture mode from the enhanced mode to the idle mode at the end of a threshold duration.

12. The apparatus of claim 1, wherein the gesture mode module further sets the gesture mode from the enhanced mode to the idle mode in response to both the detection module not detecting a triggering event and the gesture recognition module not detecting a gesture during a threshold duration.

13. A method comprising:
detecting a triggering event;
setting a gesture mode from an idle mode to an enhanced mode based on the detection of the triggering event; and
processing data from a non-contact input device to recognize gestures according to the set gesture mode.

14. The method of claim 12, wherein the non-contact input device comprises a camera and wherein the data processed in the processing step comprises a video feed.

15. The method of claim 12, wherein the idle mode comprises a coarse gesture mode and the enhanced mode comprises a fine gesture mode.

16. The method of claim 12, wherein the gesture recognition module requires less power for processing according to the idle mode than the enhanced mode.

17. The method of claim 12, wherein the triggering event does not comprise current user input.

18. The method of claim 12, wherein the detection module detects a triggering event by identifying an event that is listed in a triggering event list.

19. The method of claim 17, further comprising an update module, the update module updating the triggering event list based on one or more of:
input from a user; and
gesture recognition usage data.

20. A computer program product comprising a storage device storing machine readable code executed by a processor to perform the operations of:
detecting a triggering event;
setting a gesture mode from an idle mode to an enhanced mode based on the detection of the triggering event; and
processing data from a non-contact input device to recognize gestures according to the set gesture mode.
